(19) United States
(12) Patent Application Publication
(10) Pub. No.: US 2013/0281618 A1
(43) Pub. Date: Oct. 24, 2013

(54) LIQUID CRYSTAL ALIGNMENT AGENT, AND LIQUID CRYSTAL ALIGNMENT FILM AND LIQUID CRYSTAL DISPLAY ELEMENT FORMED FROM THE LIQUID CRYSTAL ALIGNMENT AGENT

(71) Applicant: CHI MEI CORPORATION, Tainan City (TW)

(72) Inventors: Tsung-Pei Tsai, Tainan City (TW); Huai-Pin Hsueh, Tainan City (TW)

(73) Assignee: CHI MEI CORPORATION, Tainan City (TW)

(21) Appl. No.: 13/776,936

(22) Filed: Feb. 26, 2013

(30) Foreign Application Priority Data
Apr. 24, 2012 (TW) 101114528

(51) Int. Cl. C09K 19/56

(52) U.S. Cl. CPC C09K 19/56
USPC 524/600

(57) ABSTRACT

A liquid crystal alignment agent including a polymer composition and a solvent. The polymer composition is obtained by subjecting a mixture including a tetracarboxylic dianhydride component, a multi-amine component of formula (I) defined herein, and a diamine component to a reaction. The diamine component includes a diamine compound of formula (II) defined herein.

### CROSS-REFERENCE TO RELATED APPLICATION

This application claims priority of Taiwanese Application No. 101114528, filed on Apr. 24, 2012.

### BACKGROUND OF THE INVENTION

1. Field of the Invention

This invention relates to a liquid crystal alignment agent, more particularly to a liquid crystal alignment agent having improved process stability. The invention also relates to a liquid crystal alignment film formed from the liquid crystal alignment agent, and a liquid crystal display element having improved reliability including the liquid crystal alignment film.

2. Description of the Related Art

With the increase in requirement for the wide view angle characteristic of a liquid crystal display device, the requirement for the electric and/or display characteristics of a liquid crystal display element having wide view angle has become stricter. Among the predominant types of liquid crystal display elements, the vertical alignment liquid crystal display element is most widely used in the art. In order to provide better electric and/or display characteristics, the liquid crystal alignment film has become one of the subjects investigated for enhancing the characteristics of the vertical alignment liquid crystal display element.

The liquid crystal alignment film for the vertical alignment liquid crystal display element is used for permitting the liquid crystal molecules to align regularly and permitting the liquid crystal molecules to have a large pretilt angle of about 87° to 90° when an electric field is not applied. The liquid crystal alignment film is usually formed by applying a liquid crystal alignment agent containing a polyamic acid polymer and a solvent onto a substrate followed by heating to conduct a dehydration/ring-closure reaction and then performing an alignment treatment. The polyamic acid polymer is formed by subjecting a tetracarboxylic dianhydride compound and a diamine compound to a polymerization reaction.

JP 06-308503 discloses a polyimide polymer used in the liquid crystal alignment film for a twisted nematic liquid crystal display element. The liquid crystal molecules are provided with a pretilt angle of 2°-6° when the liquid crystal alignment film is not applied with an electric field. The polyimide polymer is prepared by subjecting a tetracarboxylic dianhydride compound, a diamine compound of formula (i), and a multi-amine compound of formula (ii) to a polymerization reaction followed by a dehydration/ring-closure reaction,

H₂N-A¹-NH₂ (i)

wherein

A¹ represents an alkyl group, a cycloalkyl group, a phenyl group,

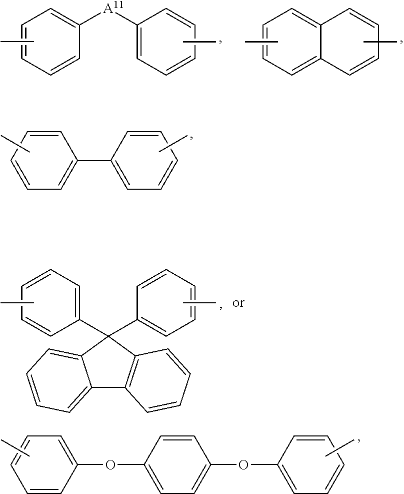

wherein A¹¹ represents an alkyl group, a haloalkyl group, a thio group, an oxo group,

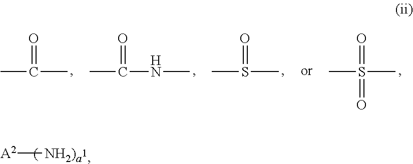

wherein

A² represents a trivalent organic group or a tetravalent organic group, and

a¹ represents 3 or 4.

The purpose of JP 06-308503 is to ensure minimal unevenness in film thickness at the time of printing. However, the polyimide polymer disclosed in the prior art is liable to be affected by the processing conditions during the alignment treatment, which results in reduction of alignment capability of the liquid crystal alignment film thus obtained and inferior uniformity of the pretilt angle of the liquid crystal molecules. Therefore, there is a problem in terms of process stability. Furthermore, when the liquid crystal display element containing the liquid crystal alignment film is tested in high temperature and high humidity conditions, there is a problem of inferior reliability. Additionally, the liquid crystal alignment film disclosed in the prior art is not useful for the vertical alignment liquid crystal display element in which a large pretilt angle is required.

### SUMMARY OF THE INVENTION

Therefore, a first object of the present invention is to provide a liquid crystal alignment agent which has superior process stability.

A second object of the present invention is to provide a liquid crystal alignment film made from the liquid crystal alignment agent.

A third object of the present invention is to provide a liquid crystal display element having superior reliability.

According to the first aspect of this invention, there is provided a liquid crystal alignment agent which includes a polymer composition and a solvent.

The polymer composition is obtained by subjecting a mixture including a tetracarboxylic dianhydride component, a multi-amine component of formula (I), and a diamine component to a reaction,

R¹NH₂)ₐ (I)

wherein

R¹ represents a trivalent organic group or a tetravalent organic group, and

a represents 3 or 4.

The diamine component includes a diamine compound of formula (II)

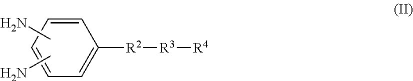

wherein

R² represents a C₁-C₁₂ alkylene group or a C₁-C₁₂ haloalkylene group,

R³ represents

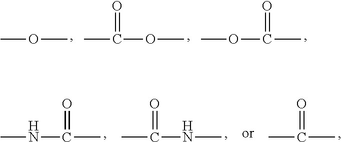

and

R⁴ represents a cholesteryl group, an organic group of formula (III), or a group of —R⁴¹-R⁴²-R⁴³,

wherein

R⁴¹ represents a C₁-C₁₀ alkylene group,

R⁴² represents

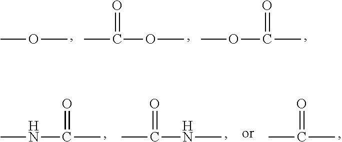

and

R⁴³ represents a cholesteryl group or an organic group of formula (III),

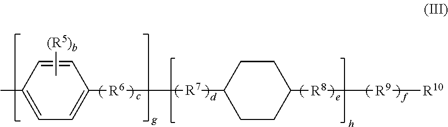

wherein

each R⁵ independently represents hydrogen, fluorine, or methyl,

each of R⁶, R⁷, and R⁸ independently represents a single bond,

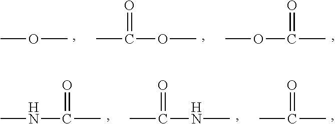

or a C₁-C₃ alkylene,

each R⁹ represents

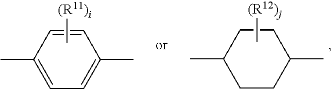

wherein

each of R¹¹ and R¹² independently represents hydrogen, fluorine, or methyl,

each R¹⁰ independently represents hydrogen, fluorine, a C₁-C₁₂ alkyl group, a C₁-C₁₂ fluoroalkyl group, a C₁-C₁₂ alkoxyl group, —OCH₂F, —OCHF₂, or —OCF₃,

b represents 1 or 2,

c, d, and e independently represent an integer ranging from 0 to 4,

f, g, and h independently represent an integer ranging from 0 to 3 with the proviso that f, g, and h are not 0 at the same time, and

i and j independently represent 1 or 2.

According to the second aspect of this invention, there is provided a liquid crystal alignment film formed from the liquid crystal alignment agent of this invention.

According to the third aspect of this invention, there is provided a liquid crystal display element including the liquid crystal alignment film of this invention.

### BRIEF DESCRIPTION OF THE DRAWING

Other features and advantages of the present invention will become apparent in the following detailed description of the preferred embodiments with reference to the accompanying drawing, of which:

FIG. 1 is a fragmentary schematic view of a preferred embodiment of a liquid crystal display element according to this invention.

### DETAILED DESCRIPTION OF THE PREFERRED EMBODIMENTS

### Liquid Crystal Alignment Agent:

The liquid crystal alignment agent of the present invention includes a polymer composition and a solvent. The polymer composition is obtained by subjecting a mixture including a tetracarboxylic dianhydride component, a multi-amine component of formula (I), and a diamine component to a reaction. The diamine component includes a diamine compound of formula (II) and an optional another diamine compound other than the diamine compound of formula (II).

A molar ratio of the diamine compound of formula (II) to the multi-amine component of formula (I) ranges preferably from 3 to 50, more preferably from 5 to 40, and most preferably from 10 to 30. When the molar ratio of the diamine compound of formula (II) to the multi-amine component of formula (I) is in the range defined above, the liquid crystal alignment agent has superior stability.

The polymer composition used in the present invention has an imidization ratio ranging generally from 30% to 80%, preferably from 35% to 80%, and more preferably from 40% to 80%. When the imidization ratio is in the range defined above, the liquid crystal display element applied with the liquid crystal alignment agent has better reliability.

The components for preparing the liquid crystal alignment agent of the present invention will now be described in detail.

### Multi-Amine Component of Formula (I):

The multi-amine component is of formula (I):

R¹NH₂)ₐ (I)

wherein

R¹ represents a trivalent organic group or a tetravalent organic group, and

a represents 3 or 4.

Examples of the organic group include, but are not limited to, an aryl group, a heterocyclic group, and

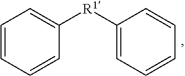

wherein R^{1′} represents an alkylene group, a haloalkyl group, a thio group, an oxo group,

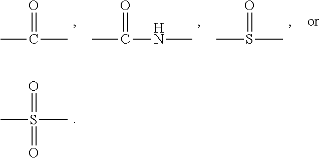

Examples of the multi-amine component of formula (I) include, but are not limited to, 1,2,4-triaminobenzene, 1,3,5-triaminobenzene, 1,2,4-triaminonaphthalene, 1,2,6-tri-aminonaphthalene, 3,3′,4-triaminodiphenyl methane, 3,3′,4-triaminodiphenyl ether, 2,4,6-triaminopyridine, 4,5,6-tri-aminopyridine, 2,4,7-triamino-6-pteridine, 2,4,6-triaminopyrimidine, 3,3′,4,4′-biphenyltetramine, 3,3′,4,4′-tetraminodiphenyl methane, 3,3′,4,4′-tetraminodiphenyl ether, 3,3′,4,4′-tetraminodiphenyl sulfone, 3,3′,4,4′-tetraminodiphenyl sulfide, 3,3′,4,4′-tetramino benzophenone, 1,2,4,5-tetraminobenzene, 1,4,5,8-tetramino anthraquinone, 2,4,5,6-tetramino pyrimidine, and tris(2-aminoethyl)amine. The aforesaid examples of the multi-amine represented by Formula (I) can be used alone or as a mixture of two or more.

Preferably, the multi-amine represented by Formula (I) is selected from 1,2,4-triaminobenzene, 1,3,5-triaminobenzene, 3,3′,4-triaminodiphenylmethane, 3,3′,4-triaminodiphenyl ether, 2,4,6-triaminopyridine, 3,3′,4,4′-biphenyltetramine, 3,3′,4,4′-tetraminodiphenyl methane, 3,3′,4,4′-tetraminodiphenyl ether, tris(2-aminoethyl)amine, and combinations thereof.

The multi-amine component of formula (I) is in an amount ranging generally from 1 mole to 10 moles, preferably from 2 moles and 10 moles, and more preferably from 3 moles to 10 moles based on 100 moles of a combination of the multi-amine component of formula (I) and the diamine component.

### Diamine Compound of Formula (II):

The diamine component used in the present invention includes the diamine compound of formula (II):

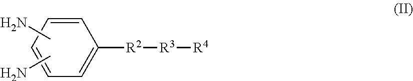

wherein

R² represents a C₁-C₁₂ alkylene group or a C₁-C₁₂ haloalkylene group,

R³ represents

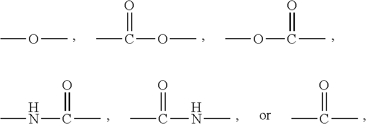

and

R⁴ represents a cholesteryl group, an organic group of formula (III), or a group of —R⁴¹-R⁴²-R⁴³,

wherein

R⁴¹ represents a C₁-C₁₀ alkylene group,

R⁴² represents

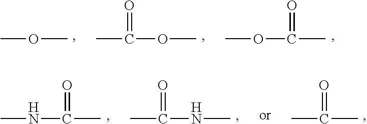

and

R⁴³ represents a cholesteryl group or an organic group of formula (III),

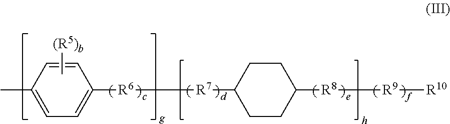

wherein

each R⁵ independently represents hydrogen, fluorine, or methyl,

each of R⁶, R⁷, and R⁸ independently represents a single bond,

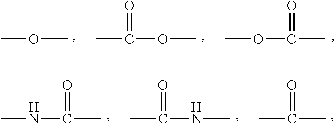

or a C₁-C₃ alkylene,

each R⁹ represents

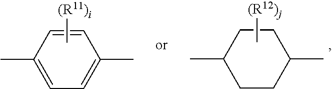

wherein

each of R¹¹ and R¹² independently represents hydrogen, fluorine, or methyl,

each R¹⁰ independently represents hydrogen, fluorine, a C₁-C₁₂ alkyl group, a C₁-C₁₂ fluoroalkyl group, a C₁-C₁₂ alkoxyl group, —OCH₂F, —OCHF₂, or —OCF₃,

b represents 1 or 2,

c, d, and e independently represent an integer ranging from 0 to 4,

f, g, and h independently represent an integer ranging from 0 to 3 with the proviso that f, g, and h are not 0 at the same time, and

i and j independently represent 1 or 2.

R² preferably represents a C₁-C₈ alkylene group.

Examples of the diamine compound of formula (II) include, but are not limited to, 1-cholesteryloxymethyl-2,4-diaminobenzene, 2-cholesteryloxyethyl-2,4-diaminobenzene, 3-cholesteryloxypropyl-2,4-diaminobenzene, 4-cholesteryloxybutyl-2,4-diaminobenzene, 1-cholesteryloxymethyl-3,5-diaminobenzene, 2-cholesteryloxyethyl-3,5-diaminobenzene, 3-cholesteryloxypropyl-3,5-diaminobenzene, 4-cholesteryloxybutyl-3,5-diaminobenzene, 1-(1-cholesteryloxy-1,1-difluoromethyl)-2,4-diaminobenzene, 1-(2-cholesteryloxy-1,1,2,2-tetrafluoroethyl)-2,4-diaminobenzene, 1-(3-cholesteryloxy-1,1,2,2,3,3-hexafluoropropyl)-2,4-diaminobenzene, 1-(4-cholesteryloxy-1,1,2,2,3,3,4,4-octafluorobutyl)-2,4-diaminobenzene, 1-(1-cholesteryloxy-1,1-difluoromethyl)-3,5-diaminobenzene, 1-(2-cholesteryloxy-1,1,2,2-tetrafluoroethyl)-3,5-diaminobenzene, 1-(3-cholesteryloxy-1,1,2,2,3,3-hexafluoropropyl)-3,5-diaminobenzene, 1-(4-cholesteryloxy-1,1,2,2,3,3,4,4-octafluorobutyl)-3,5-diaminobenzene, 1-cholestanyloxymethyl-2,4-diaminobenzene, 2-cholestanyloxyethyl-2,4-diaminobenzene, 3-cholestanyloxypropyl-2,4-diaminobenzene, 4-cholestanyloxybutyl-2,4-diaminobenzene, 1-cholestanyloxymethyl-3,5-diaminobenzene, 2-cholestanyloxyethyl-3,5-diaminobenzene, 3-cholestanyloxypropyl-3,5-diaminobenzene, 4-cholestanyloxybutyl-3,5-diaminobenzene, 1-(1-cholestanyloxy-1,1-difluoromethyl)-2,4-diaminobenzene, 1-(2-cholestanyloxy-1,1,2,2-tetrafluoroethyl)-2,4-diaminobenzene, 1-(3-cholestanyloxy-1,1,2,2,3,3-hexafluoropropyl)-2,4-diaminobenzene, 1-(4-cholestanyloxy-1,1,2,2,3,3,4,4-octafluoropropyl)-2,4-diaminobenzene, 1-(1-cholestanyloxy-1,1-difluoromethyl)-3,5-diaminobenzene, 1-(2-cholestanyloxy-1,1,2,2-tetrafluoroethyl)-3,5-diaminobenzene, 1-(3-cholestanyloxy-1,1,2,2,3,3-hexafluoropropyl)-3,5-diaminobenzene, 1-(4-cholestanyloxy-1,1,2,2,3,3,4,4-octafluoropropyl)-3,5-diaminobenzene, 3-(2,4-diaminophenylmethoxy)-4,4-dimethylcholestane, 3-(2-(2,4-diaminophenyl)ethoxy)-4,4-dimethylcholestane, 3-(3-(2,4-diaminophenyl)propoxy)-4,4-dimethylcholestane, 3-(4-(2,4-diaminophenyl)butoxy)-4,4-dimethylcholestane, 3-(3,5-diaminophenylmethoxy)-4,4-dimethylcholestane, 3-(2-(3,5-diaminophenyl)ethoxy)-4,4-dimethylcholestane, 3-(3-(3,5-diaminophenyl)propoxy)-4,4-dimethylcholestane, 3-(4-(3,5-diaminophenyl)butoxy)-4,4-dimethylcholestane, 3-(1-(2,4-diaminophenyl)-1,1-difluoromethoxy)-4,4-dimethylcholestane, 3-(2-(2,4-diaminophenyl)-1,1,2,2-tetrafluoromethoxy)-4,4-dimethylcholestane, 3-(3-(2,4-diaminophenyl)-1,1,2,2,3,3-hexafluoromethoxy)-4,4-dimethylcholestane, 3-(4-(2,4-diaminophenyl)-1,1,2,2,3,3,4,4-octafluoromeothoxy)-4,4-dimethylcholestane, 3-(1-(3,5-diaminophenyl)-1,1-difluoromethoxy)-4,4-dimethylcholestane, 3-(2-(3,5-diaminophenyl)-1,1,2,2-tetrafluoromethoxy)-4,4-dimethylcholestane, 3-(3-(3,5-diaminophenyl)-1,1,2,2,3,3-hexafluoromethoxy)-4,4-dimethylcholestane, 3-(4-(3,5-diaminophenyl)-1,1,2,2,3,3,4,4-octafluoromethoxy)-4,4-dimethylcholestane, 3-(2,4-diaminophenyl)methoxycholane-24-oic hexadecyl ester, 3-(2-(2,4-diaminophenyl)ethoxy)cholane-24-oic hexadecyl ester, 3-(3-(2,4-diaminophenyl)propoxy)cholane-24-oic hexadecyl ester, 3-(4-(2,4-diaminophenyl)butoxy)cholane-24-oic hexadecyl ester, 3-(3,5-diaminophenyl)methoxycholane-24-oic hexadecyl ester, 3-(2-(3,5-diaminophenyl)ethoxy)cholane-24-oic hexadecyl ester, 3-(3-(3,5-diaminophenyl)propoxy)cholane-24-oic hexadecyl ester, 3-(4-(3,5-diaminophenyl)butoxy)cholane-24-oic hexadecyl ester, 3-(1-(3,5-diaminophenyl)-1,1-difluoromethoxy)cholane-3-(2-(3,5-diaminophenyl)-1,1,2,2-tetrafluoromethoxy)cholane-24-oic hexadecyl ester, 3-(3-(3,5-diaminophenyl)-1,1,2,2,3,3-hexafluoropropoxy)cholane-24-oic hexadecyl ester, 3-(4-(3,5-diaminophenyl)-1,1,2,2,3,3,4,4-octafluoropropoxy)cholane-24-oic hexadecyl ester, 3-(3,5-diaminophenyl)methoxycholane-24-oic stearyl ester, 3-(2-(3,5-diaminophenyl)ethoxy)cholane-24-oic stearyl ester, 3-(3-(3,5-diaminophenyl)propoxy)cholane-24-oic stearyl ester, 3-(4-(3,5-diaminophenyl)butoxy)cholane-24-oic stearyl ester, 3-(1-(3,5-diaminophenyl)-1,1-difluoromethoxy)cholane-24-oic stearyl ester, 3-(2-(3,5-diaminophenyl)-1,1,2,2-tetrafluoromethoxy)cholane-24-oic stearyl ester, 3-(3-(3,5-diaminophenyl)-1,1,2,2,3,3-hexafluoropropoxy)cholane-24-oic stearyl ester, 3-(4-(3,5-diaminophenyl)-1,1,2,2,3,3,4,4-octafluoropropoxy)cholane-24-oic stearyl ester,

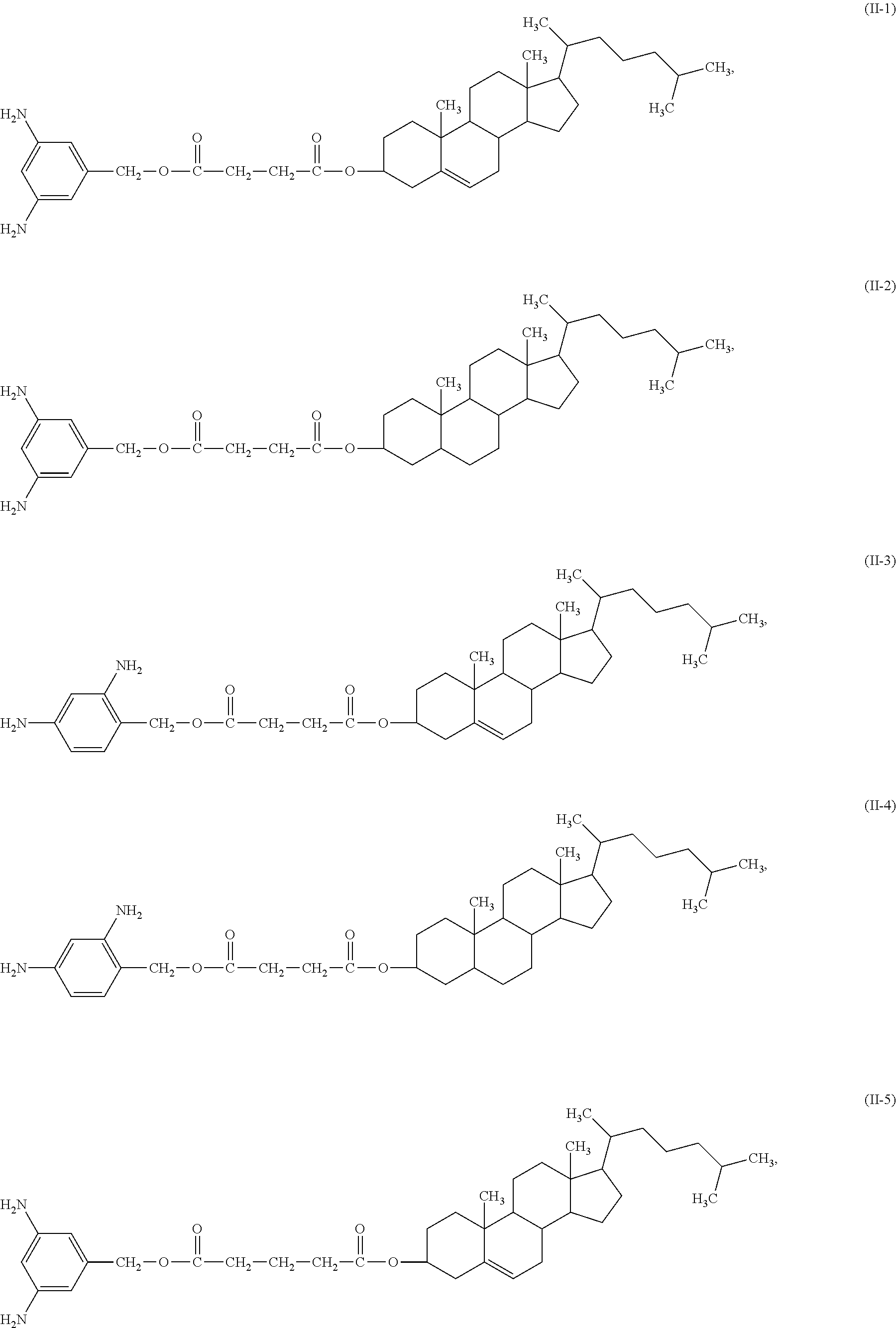 [SMILES: CC(C)CCCC(C)C1CCC2C3CC=C4CC(OC(=O)CCC(=O)OCc5cc(N)cc(N)c5)CCC4(C)C3CCC12C ; CC(C)CCCC(C)C1CCC2C3CCC4CC(OC(=O)CCC(=O)OCc5cc(N)cc(N)c5)CCC4(C)C3CCC12C ; CC(C)CCCC(C)C1CCC2C3CC=C4CC(OC(=O)CCC(=O)OCc5ccc(N)cc5N)CCC4(C)C3CCC12C ; CC(C)CCCC(C)C1CCC2C3CCC4CC(OC(=O)CCC(=O)OCc5ccc(N)cc5N)CCC4(C)C3CCC12C ; CC(C)CCCC(C)C1CCC2C3CC=C4CC(OC(=O)CCCC(=O)OCc5cc(N)cc(N)c5)CCC4(C)C3CCC12C]

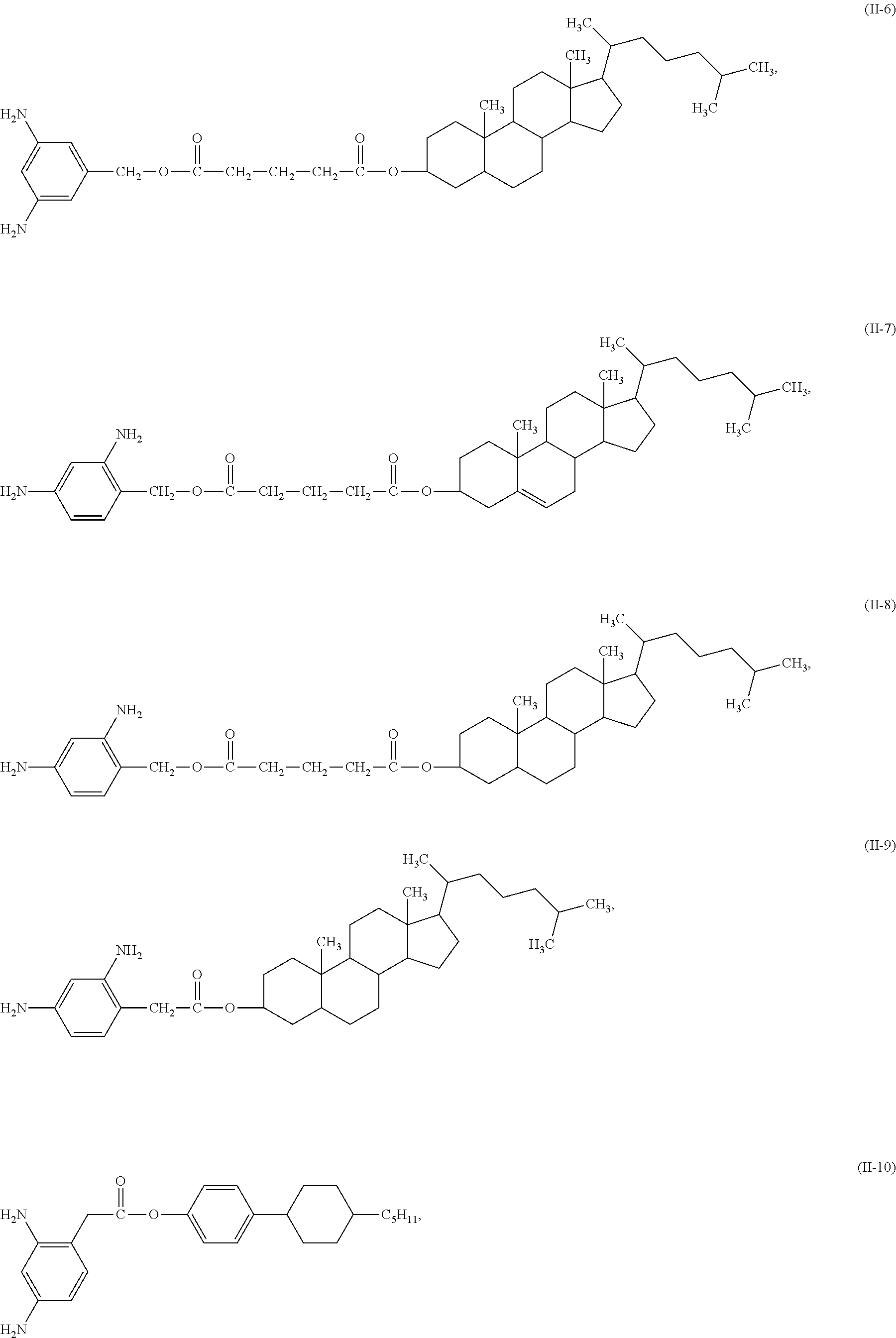

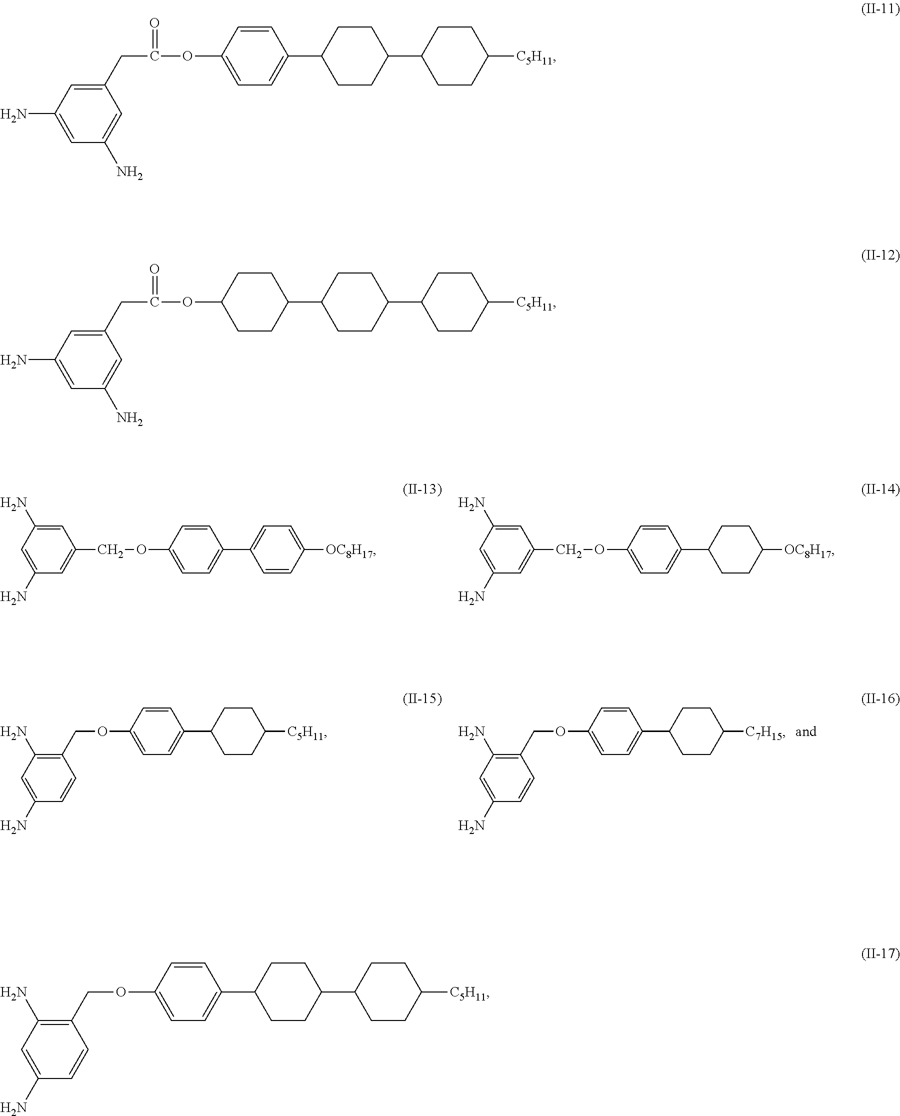

The aforesaid examples of the diamine compound represented by Formula (II) can be used alone or as a mixture of two or more.

Preferably, the diamine compound represented by Formula (II) is selected from 1-cholesteryloxymethyl-2,4-diaminobenzene, 2-cholesteryloxyethyl-2,4-diaminobenzene, 1-cholesteryloxymethyl-3,5-diaminobenzene, 2-cholesteryloxyethyl-3,5-diaminobenzene, 1-cholestanyloxymethyl-2,4-diaminobenzene, 2-cholestanyloxyethyl-2,4-diaminobenzene, 1-cholestanyloxymethyl-3,5-diaminobenzene, 2-cholestanyloxyethyl-3,5-diaminobenzene, compounds of formulas (II-1), (II-9), (II-10), (II-11), (II-15), and (II-16), and combinations thereof. Examples of the diamine compound represented by Formula (II) are products such as TWDM-21 and TWDM-23 manufactured by Wako.

The diamine compound represented by Formula (II) is in an amount ranging generally from 5 mole to 70 moles, preferably from 8 moles and 60 moles, and more preferably from 10 moles to 50 moles based on 100 moles of a combination of the multi-amine component of formula (I) and the diamine component.

When the mixture for obtaining the polymer composition does not contain both the multi-amine represented by Formula (I) and the diamine represented by Formula (II), the liquid crystal alignment agent produced therefrom does not have superior process stability and the liquid crystal display element applied with the liquid crystal alignment agent does not have better reliability.

Another Diamine Compound Other than Diamine Compound of Formula (II):

Examples of another diamine compound other than the diamine compound of Formula (II) include, but are not limited to, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylene diamine, tricyclic[6.2.1.0^{2,7}]-undecylenedimethylene diamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4′-aminophenyl)-1,3,3-trimethylindane, hexahydro-4,7-methanoindanylenedimethylene diamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-bis[(4-amino-2-trifluoromethyl)phenoxy]octafluorobiphenyl, 5-[4-(4-n-pentylcyclohexyl)cyclohexyl]phenylmethylene-1,3-diaminobenzene, 1,1-bis[4-4-aminophenoxy)phenyl]-4-(4-ethylphenyl)cyclohexane, and diamine compounds of formulas (a)-(p),

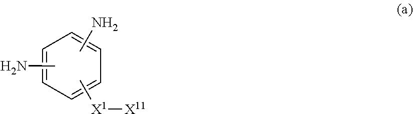

wherein X¹ represents

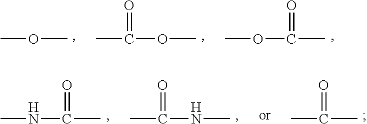

X¹¹ represents a monovalent group having a group selected from the group consisting of a steroid-containing group, a trifluoromethyl group, a fluoro group, a C₂-C₃₀ alkyl group, and a monovalent nitrogen-containing cyclic structure derived from the group consisting of pyridine, pyrimidine, triazine, piperidine and piperazine,

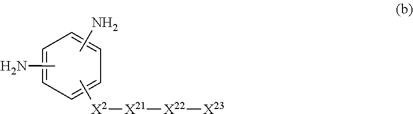

wherein X² represents

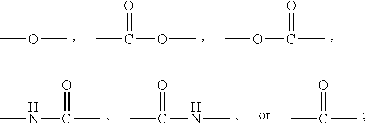

X²¹ and X²² independently represent a divalent group which is selected from the group consisting of an alicyclic group, an aromatic group, and a heterocyclic group; and X²³ represents a C₃-C₁₈ alkyl group, a C₃-C₁₈ alkoxy group, a C₁-C₅ fluoroalkyl group, a C₁-C₅ fluoroalkoxy group, a cyano group, or a halogen atom,

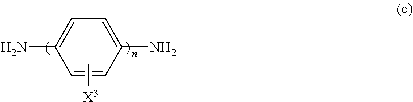

wherein X³ represents hydrogen, a C₁-C₅ acyl group, a C₁-C₅ alkyl group, a C₁-C₅ alkoxy group, or halogen; X³ in each repeating unit may be the same or different; and n is an integer ranging from 1 to 3,

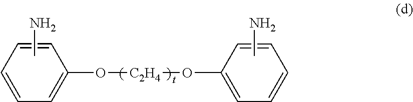

wherein t is an integer ranging from 2 to 12,

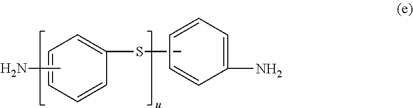

wherein u is an integer ranging from 1 to 5,

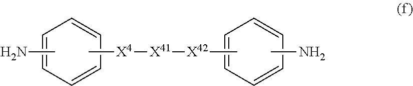

wherein X⁴ and X⁴² may be the same or different, and independently represent a divalent organic group; and X⁴¹ represents a divalent group that has a ring structure containing a nitrogen atom and that is derived from the group consisting of pyridine, pyrimidine, triazine, piperidine and piperazine,

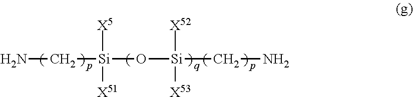

wherein X⁵, X⁵¹, X⁵², and X⁵³ may be the same or different, and independently represent a C₁-C₁₂ hydrocarbon group; p is an integer ranging from 1 to 3; and q is an integer ranging from 1 to 20,

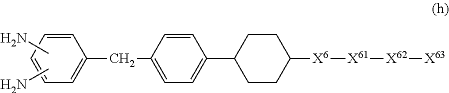

wherein X⁶ represents —O— or cyclohexylene; X⁶¹ represents —CH₂—; X⁶² represents phenylene or cyclohexylene; and X⁶³ represents hydrogen or heptyl,

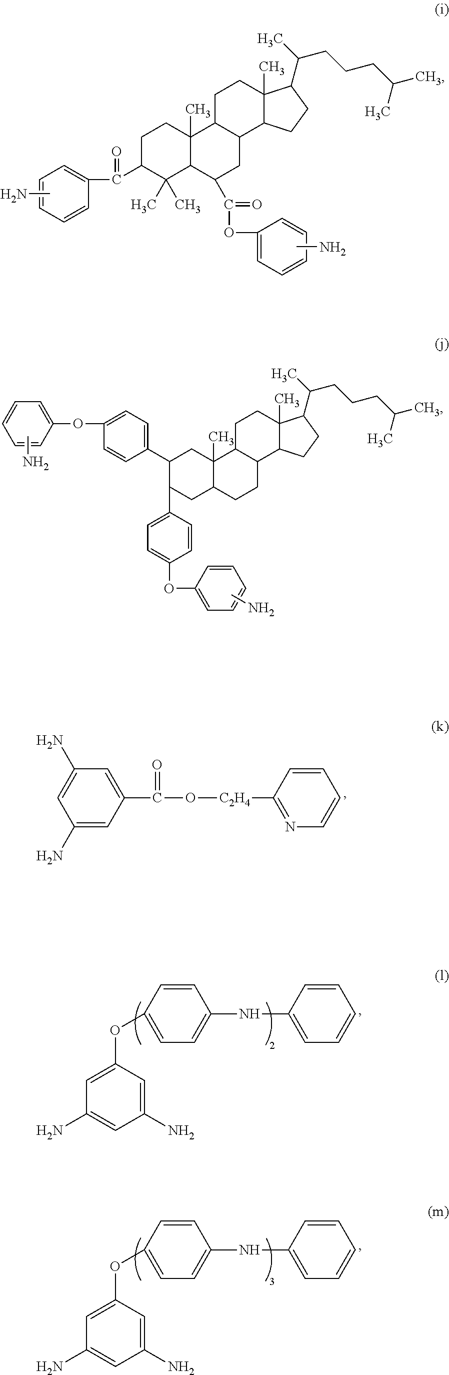

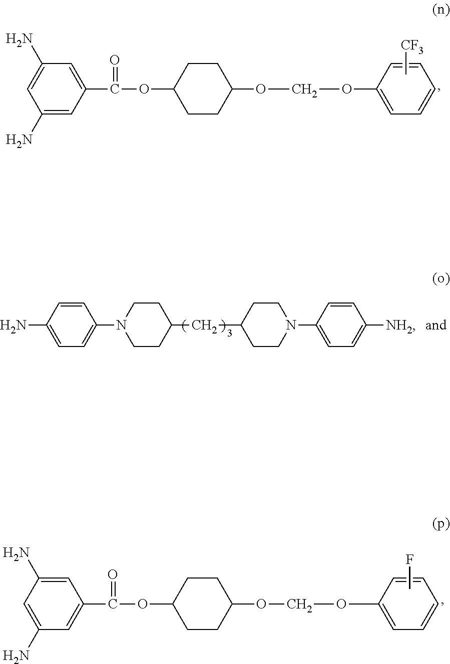

The aforesaid examples of the another diamine compound can be used alone or as a mixture of two or more.

Preferred examples of the diamine compounds represented by formula (a) include 2,4-diaminophenylethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene,

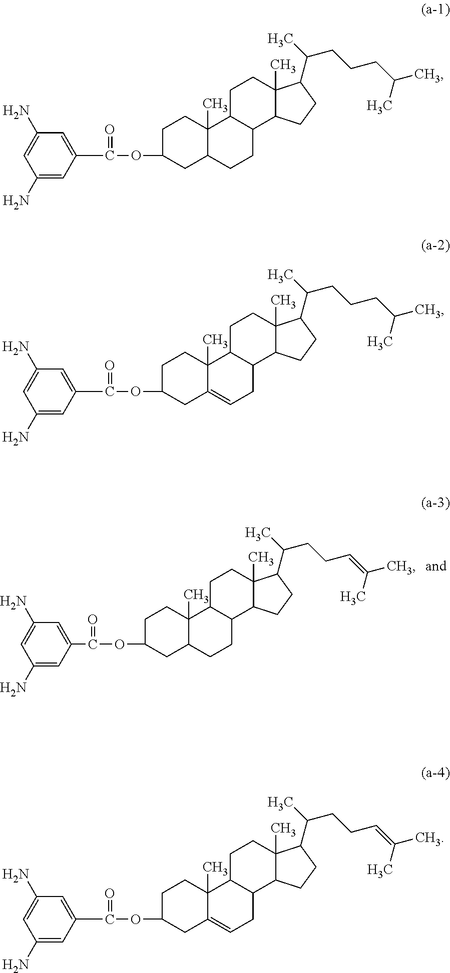 [SMILES: CC(C)CCCC(C)C1CCC2C3CCC4CC(OC(=O)c5cc(N)cc(N)c5)CCC4(C)C3CCC12C ; CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; CC(C)=CCCC(C)C1CCC2C3CC=C4CC(OC(=O)c5cc(N)cc(N)c5)CCC4(C)C3CCC12C]

Preferred examples of the diamine compounds represented by formula (b) include

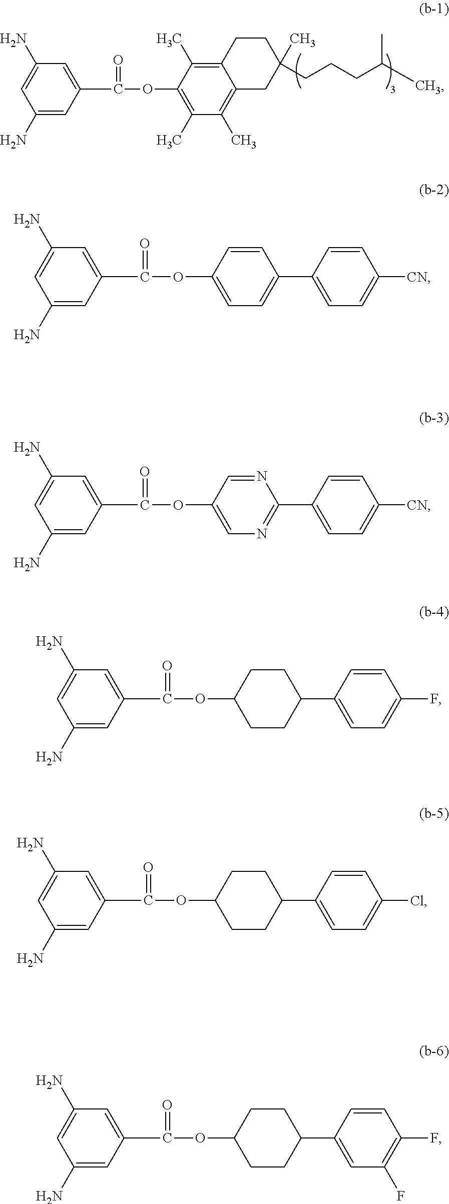

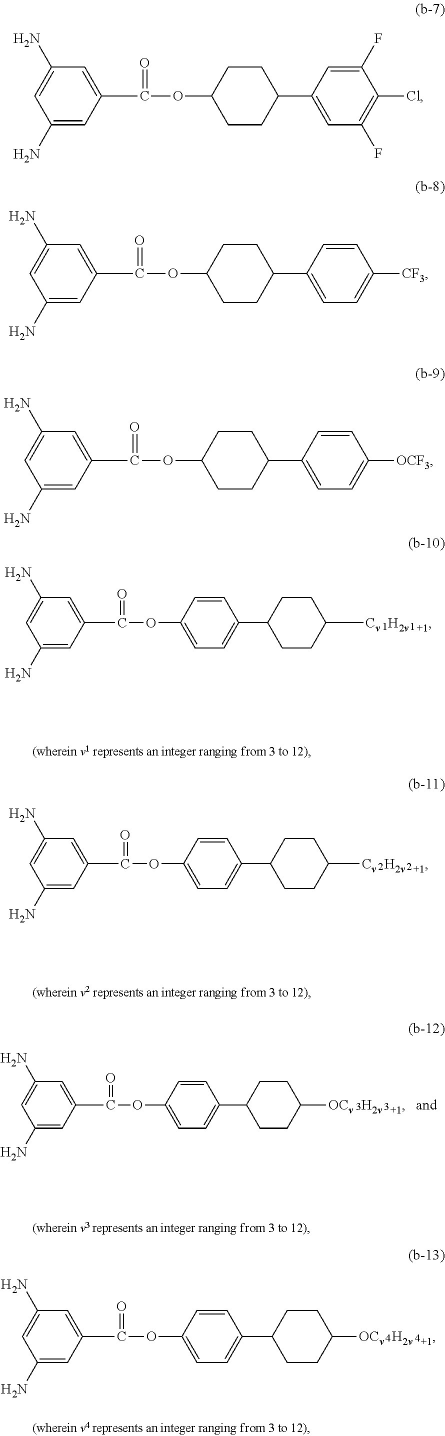

Preferred examples of the diamine compound represented by formula (c) include: (1) p-diaminobenzene, m-diaminobenzene, o-diaminobenzene, 2,5-diaminotoluene, or the like when n is 1; (2) 4,4′-diaminobiphenyl, 2,2′-dimethyl-4,4′-diaminobiphenyl, 3,3′-dimethyl-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trifluoromethyl)biphenyl, or the like when n is 2; and (3) 1,4-bis(4′-aminophenyl)benzene, or the like when n is 3. More preferably, the diamine compound represented by formula (c) is selected from p-diaminobenzene, 2,5-diaminotoluene, 4,4′-diaminobiphenyl, 3,3′-dimethoxy-4,4′-diaminobiphenyl, and 1,4-bis(4′-aminophenyl)benzene.

Preferably, the diamine compound represented by formula (e) is 4,4′-diaminodiphenylsulfide.

Preferably, the diamine compound represented by formula (h) is selected from

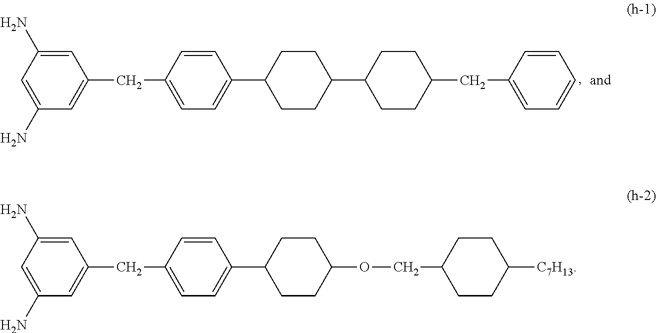

Preferred examples of the another diamine compound suitable for the present invention include, but are not limited to, 1,2-diaminoethane, 4,4′-diaminodicyclohexylmethane, 4,4′-diaminodiphenylmethane, 4,4′-diaminodiphenylether, 5-[4-(4-n-pentylcyclohexyl)cyclohexyl]phenylmethylene-1,3-diaminobenzene, 1,1-bis[4-4-amino-phenoxy)phenyl]-4-(4-ethylphenyl)cyclohexane, 2,4-diaminophenyl ethyl formate, the diamine compounds represented by formulae (a-1), (a-2), (b-1), and (b-11), p-diaminobenzene, m-diaminobenzene, o-diaminobenzene, and the diamine compound represented by formula (h-1).

### Tetracarboxylic Dianhydride Component:

The tetracarboxylic dianhydride component includes at least one tetracarboxylic dianhydride compound selected from: (1) an aliphatic tetracarboxylic dianhydride compound, (2) an alicyclic tetracarboxylic dianhydride compound, (3) an aromatic tetracarboxylic dianhydride compound, (4) a teracarboxylic dianhydride compound represented by the following formulas (I)-(6), and combinations thereof.

(i): Examples of the aliphatic tetracarboxylic dianhydride compound include, but are not limited to, ethanetetracarboxylic dianhydride and butanetetracarboxylic dianhydride.

(ii): Examples of the alicyclic tetracarboxylic dianhydride compound include, but are not limited to, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexane tetracarboxylic dianhydride, cis-3,7-dibutylcycloheptyl-1,5-diene-1,2,5,6-tetracarboxylic dianhydride, 2,3,5-tricarboxylcyclopentylacetic dianhydride, and bicyclo[2.2.2]-octa-7-ene-2,3,5,6-tetracarboxylic dianhydride.

(iii): Examples of the aromatic tetracarboxylic dianhydride compound include, but are not limited to, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-biphenylethanetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-diphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenyl ether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofurantetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3-dione, 1,3,3a,4,5,9b-hexahydro-7-ethyl-5-(tetrahydro-2,5-dioxo-3-furanyl)-naphtho[1,2-c]-furan-1,3-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, and 5-(2,5-dioxotetrahydrofuranyl)-3-methyl-3-cyclohexene-1,2-dicarboxylic dianhydride.

(iv): The teracarboxylic dianhydride compounds represented by the following formulas (1)-(6):

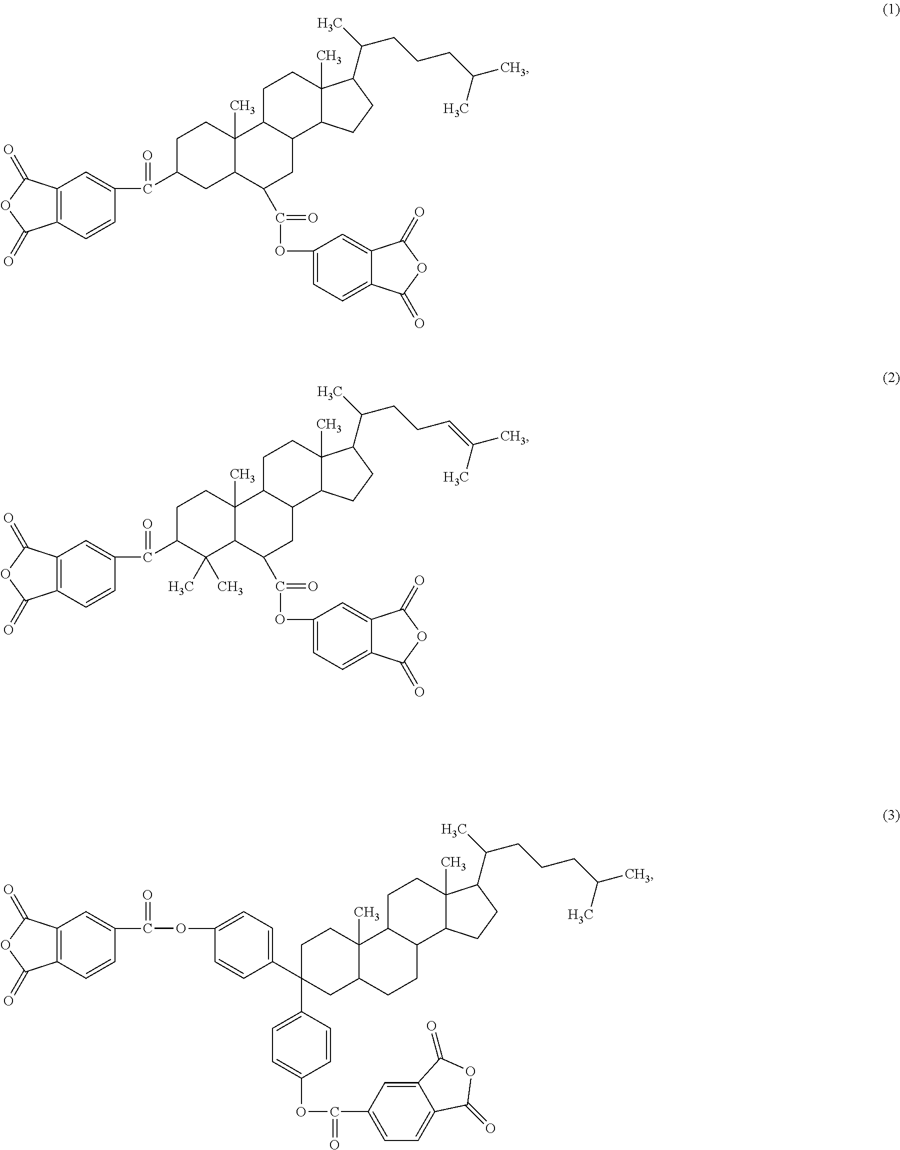

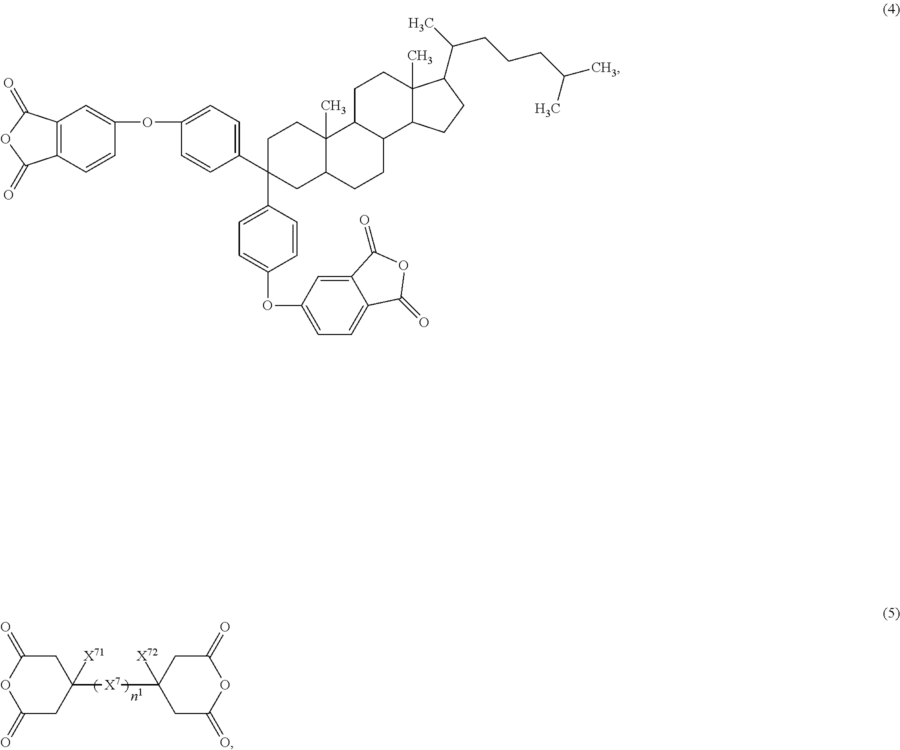

wherein X⁷ represents a divalent group having an aromatic ring structure; n¹ represents an integer ranging from 1 to 2; and X⁷¹ and X⁷² may be the same or different, and independently represent hydrogen or an alkyl group, and

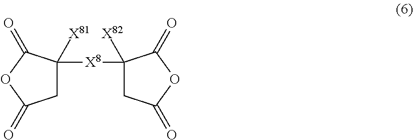

wherein X⁸ represents a divalent group having an aromatic ring structure; and X⁸¹ and X⁸² may be the same or different, and independently represent hydrogen or an alkyl group.

Preferably, the tetracarboxylic dianhydride compound represented by formula (5) is selected from

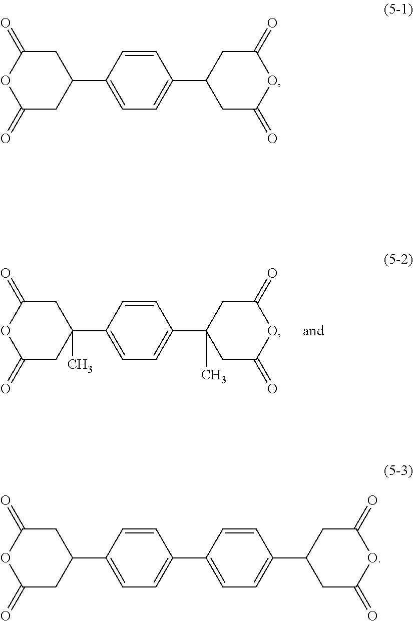 [SMILES: O=C1CC(c2ccc(C3CC(=O)OC(=O)C3)cc2)CC(=O)O1 ; CC1(c2ccc(C3(C)CC(=O)OC(=O)C3)cc2)CC(=O)OC(=O)C1 ; O=C1CC(c2ccc(-c3ccc(C4CC(=O)OC(=O)C4)cc3)cc2)CC(=O)O1]

Preferably, the tetracarboxylic dianhydride compound represented by formula (6) is

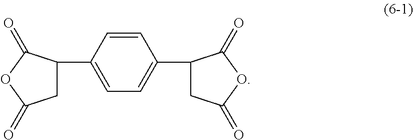 [SMILES: O=C1CC(c2ccc(C3CC(=O)OC3=O)cc2)C(=O)O1]

Preferred examples of the tetracarboxylic dianhydride compound suitable for the present invention include, but are not limited to, 1,2,3,4-cyclobutane tetracarboxylic dianhydride, 1,2,3,4-cyclopentanetetracarboxylic dianhydride, 2,3,5-tricarboxycyclopentylacetic dianhydride, 1,2,4,5-cyclohexanetetracarboxylic dianhydride, 3,4-dicarboxy-1,2,3,4-tetrahydronaphthalene-1-succinic acid dianhydride, pyromellitic dianhydride, 3,3′,4,4′-benzophenonetetracarboxylic dianhydride, and 3,3′,4,4′-biphenylsulfonetetracarboxylic dianhydride.

The polymer composition includes a polyamic acid compound, a polyimide compound, a polyimide series block copolymer, or combinations thereof.

### Polyamic Acid Compound:

Polyamic acid compound is obtained by subjecting the tetracarboxylic dianhydride component, the multi-amine component represented by formula (I), and the diamine component to a polycondensation reaction. The polycondensation reaction is conducted in a solvent at a temperature ranging from 0 to 100° C. for a period ranging from 1 to 24 hours to obtain a reaction solution. The reaction solution is distillated under a reduced pressure in a distiller to obtain polyamic acid. Alternatively, the reaction solution can be treated by pouring it into a large amount of poor solvent to obtain a precipitate, which is then dried under a reduced pressure to obtain polyamic acid.

The tetracarboxylic dianhydride component is used in an amount ranging preferably from 20 to 200 moles and more preferably from 30 to 120 moles based on 100 moles of a combination of the diamine component and the multi-amine component represented by formula (I).

The solvent for the polycondensation reaction may be the same as or different from the solvent used in the liquid crystal alignment agent. Furthermore, there is no particular limitation to the solvent for the polycondensation reaction as long as the solvent is able to dissolve the reactants and the products. Examples of the solvent for the polycondensation reaction include, but are not limited to, (1) aprotic polar solvents, such as 1-methyl-2-pyrrolidone, N,N-dimethylacetamide, N,N-dimethylformamide, dimethylsulfoxide, γ-butyrolactone, tetramethylurea, hexamethylphosphoric acid triamide, and the like; and (2) phenolic solvents, such as m-cresol, xylenol, phenol, halogenated phenols, and the like.

The solvent for the polycondensation reaction is used in an amount ranging preferably from 200 to 2,000 parts by weight and more preferably from 300 to 1,800 parts by weight based on 100 parts by weight of the mixture of the tetracarboxylic dianhydride component, the multi-amine component, and the diamine component.

The aforementioned solvent for the polycondensation reaction can be used in combination with a poor solvent in such an amount that does not cause precipitation of the formed polyamic acid. Examples of the poor solvent include, but are not limited to, (1) alcohols, such as methyl alcohol, ethyl alcohol, isopropyl alcohol, cyclohexanol, ethylene glycol, propylene glycol, 1,4-butanediol, triethylene glycol, or the like; (2) ketones, such as acetone, methyl ethyl ketone, methyl isobutyl ketone, cyclohexanone, or the like; (3) esters, such as methyl acetate, ethyl acetate, butyl acetate, diethyl oxalate, diethyl malonate, ethylene glycol ethyl ether acetate, or the like; (4) ethers, such as diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether, or the like; (5) halogenated hydrocarbons, such as dichloromethane, 1,2-dichloroethane, 1,4-dichlorobutane, trichloroethane, chlorobenzene, o-dichlorobenzene, or the like; (6) hydrocarbons, such as tetrahydrofuran, hexane, heptane, octane, benzene, toluene, xylene, or the like; and combinations thereof. The examples of the poor solvent may be used alone or in admixture of two or more.

The poor solvent is used in an amount ranging preferably from 0 to 60 parts by weight and more preferably from 0 to 50 parts by weight based on 100 parts by weight of a combination of the diamine component and the multi-amine component represented by formula (I).

### Polyimide Compound:

The polyimide compound is obtained by subjecting the tetracarboxylic dianhydride component, the multi-amine component represented by formula (I), and the diamine component to a polycondensation reaction in a solvent to obtain polyamic acid followed by a dehydration/ring-closure reaction, which is conducted by heating in the presence of a dehydrating agent and a catalyst. The amic acid functional group of the polyamic acid is converted (i.e., imidized) to the imido functional group via the dehydration/ring-closure reaction so as to obtain the polyimide compound.

The tetracarboxylic dianhydride component, the multi-amine component represented by formula (I), and the diamine component for preparation of the polyimide compound may be the same as the tetracarboxylic dianhydride component, the multi-amine component represented by formula (I), and the diamine component for obtaining the polyamic acid compound.

The solvent for the dehydration/ring-closure reaction may be the same as the solvent used in the liquid crystal alignment agent. The solvent for the dehydration/ring-closure reaction is used in an amount ranging preferably from 200 to 2,000 parts by weight and more preferably from 300 to 1,800 parts by weight based on 100 parts by weight of the polyamic acid compound.

Heating temperature for the dehydration/ring-closure reaction is preferably from 40° C. to 200° C. and more preferably from 40° C. to 150° C. If the heating temperature of the dehydration/ring-closure reaction is lower than 40° C., the dehydration ring-closing reaction may not be fully implemented and the imidization ratio would be unsatisfactory. If the reaction temperature exceeds 200° C., the weight average molecular weight of the obtained polyimide compound would be reduced.

Examples of the dehydrating agent suitable for the dehydration ring-closing reaction include acid anhydride compounds, such as acetic anhydride, propionic anhydride, trifluoroacetic anhydride, or the like. The used amount of the dehydrating agent is preferably from 0.01 to 20 moles per mole of the polyamic acid compound. Examples of the catalyst suitable for the dehydration ring-closing reaction include pyridine compounds, such as pyridine, trimethylpyridine, dimethylpyridine, or the like; and tertiary amines, such as triethylamine, or the like. The used amount of the catalyst is preferably from 0.5 to 10 moles per mole of the dehydrating agent.

### Polyimide Series Block Copolymer:

The polyimide series block copolymer comprises polyamic acid block copolymer, polyimide block copolymer, polyamic acid-polyimide block copolymer, or combinations thereof.

The polyimide series block copolymer is obtained by further polycondensation reaction of a starting material which includes at least one of the aforesaid polyamic acid compounds and/or at least one of the aforesaid polyimide compounds and which can further include a tetracarboxylic dianhydride component, a multi-amine component, and a diamine component in a solvent.

The tetracarboxylic dianhydride component, the multi-amine component, and the diamine component included in the strating material may be the same as the tetracarboxylic dianhydride component, the multi-amine component, and the diamine component used for the preparation of the polyamic acid compound, and the solvent used for obtaining the polyimide series block copolymer may be the same as the solvent used for the preparation of the liquid crystal alignment agent.

The solvent for obtaining the polyimide series block copolymer is used in an amount ranging preferably from 200 to 2,000 parts by weight and more preferably from 300 to 1,800 parts by weight based on 100 parts by weight of the starting material used for obtaining the polyimide series block copolymer. In the polycondensation reaction for the polyimide series block copolymer, the reaction temperature is generally from 0 to 200° C. and preferably from 0 to 100° C.

Preferably, examples of the starting material used for obtaining the polyimide series block copolymer include, but are not limited to: (1) first and second polyamic acid compounds which are different from each other in terminal groups and structures thereof; (2) first and second polyimide compounds which are different from each other in terminal groups and structures thereof; (3) a polyamic acid compound and a polyimide compound which are different from each other in terminal groups and structures thereof; (4) a polyamic acid compound, a tetracarboxylic dianhydride component, and a diamine component, wherein at least one of the tetracarboxylic dianhydride component and the diamine component is structurally different from the one used for obtaining the polyamic acid compound; (5) a polyimide compound, a tetracarboxylic dianhydride component, and a diamine component, wherein at least one of the tetracarboxylic dianhydride component and the diamine component is structurally different from the one used for obtaining the polyimide compound; (6) a polyamic acid compound, a polyimide compound, a tetracarboxylic dianhydride component, and a diamine component, wherein at least one of the tetracarboxylic dianhydride component and the diamine component is structurally different from the ones used for obtaining the polyamic acid compound and the polyimide compound; (7) first and second polyamic acid compounds, a tetracarboxylic dianhydride component, and a diamine component, wherein the first and second polyamic acid compounds are structurally different from each other; (8) first and second polyimide compounds, a tetracarboxylic dianhydride component, and a diamine component, wherein the first and second polyimide compounds are structurally different from each other; (9) first and second polyamic acid compounds and a diamine component, wherein the first and second polyamic acid compounds have anhydride terminal groups and are structurally different from each other; (10) first and second polyamic acid compounds and a tetracarboxylic dianhydride component, wherein the first and second polyamic acid compounds have amino terminal groups and are structurally different from each other; (11) first and second polyimide compounds and a diamine component, wherein the first and second polyimide compounds have anhydride terminal groups and are structurally different from each other; and (12) first and second polyimide compounds and a tetracarboxylic dianhydride component, wherein the first and second polyimide compounds have amino terminal groups and are structurally different from each other.

Preferably, the polyamic acid compound, the polyimide compound, and the polyimide series block copolymer can also be the polymers which are terminal-modified after an adjustment of molecular weight thereof as long as the desirable effects of the present invention are not reduced. The terminal-modified polymers can be used to improve the coating performance of the liquid crystal alignment agent. The process for synthesizing the terminal-modified polymers involves adding a monofunctional compound to the reaction system during the polycondensation reaction for the polyamic acid compound.

Examples of the monofunctional compound include, but are not limited to, (1) monoanhydride compounds, such as maleic anhydride, phthalic anhydride, itaconic anhydride, n-decyl succinic anhydride, n-dodecyl succinic anhydride, n-tetradecyl succinic anhydride, n-hexadecyl succinic anhydride, and the like; (2) monoamine compounds, such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, n-eicosylamine, and the like; and (3) monoisocyanate compounds, such as phenyl isocyanate, naphthyl isocyanate, and the like.

### Solvent:

Preferably, the solvent used in the liquid crystal alignment agent of the present invention is selected from 1-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylethanamide, and the like. The examples of the solvent may be used alone or in admixture of two or more.

In order to provide the liquid crystal alignment agent with superior printability, the solvent used in the liquid crystal alignment agent is in an amount ranging preferably from 1,000 to 2,000 parts by weight and more preferably from 1,200 to 2,000 parts by weight based on 100 parts by weight of the polymer composition.

### Additives:

The additives such as epoxy compounds or silane compounds containing functional groups may be added to the liquid crystal alignment agent of the present invention so as to improve adhesion of the liquid crystal alignment agent to a substrate as long as the intended properties of the liquid crystal alignment agent are not impaired. The additives may be used alone or in admixture of two or more.

Examples of the silane compounds containing functional groups include, but are not limited to, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane.

Examples of the epoxy compounds include, but are not limited to, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerin diglycidyl ether, 2,2-dibromo-neopentyl glycol diglycidyl ether, 1,3,5,6-tetragylcidyl-2,4-hexanediol, N,N,N′,N′-tetragylcidyl-m-xylenediamine, 1,3-bis(N,N-digylcidylaminomethyl)cyclohexane, N,N,N′,N′-tetragylcidyl-4,4′-diaminodiphenylmethane, N,N-gylcidyl-p-glycidoxyaniline, 3-(N-allyl-N-glycidyl)aminopropyltrimethoxysilane, and 3-(N,N-diglycidyl)aminopropyltrimethoxysilane.

There is no specific limitation to the method for preparing the liquid crystal alignment agent of the present invention. The general mixing method can be used. For example, the liquid crystal alignment agent of the present invention can be made by mixing at least one polyamic acid compound, and/or at least one polyimide compound, and/or at least one polyimide series block copolymer to obtain the polymer composition, which is then added with the solvent and optional additives at a temperature ranging from 0 to 200° C. and preferably from 20° C. to 60° C. followed by stirring until the polymer composition is dissolved in the solvent.

The additives are in an amount ranging preferably from 0.5 to 50 parts by weight and more preferably from 1 to 45 parts by weight based on 100 parts by weight of the polymer composition.

The viscosity of the liquid crystal alignment agent is in a range preferably from 15 cps to 40 cps, more preferably from 18 cps to 35 cps, and most preferably from 20 cps to 30 cps at a temperature of 25° C. When the viscosity of the liquid crystal alignment agent is in the range defined above, the liquid crystal alignment agent has superior process stability and the liquid crystal display element containing the liquid crystal alignment film formed from the liquid crystal alignment agent has better reliability.

### Liquid Crystal Alignment Film:

The prepared liquid crystal alignment agent is applied to a substrate by a roller coating method, a spinner coating method, a printing method, an ink-jet method, or the like to form a coating film. The coating film is then treated by a pre-bake treatment, a post-bake treatment and an alignment treatment to obtain a liquid crystal alignment film.

The pre-bake treatment causes the solvent to volatilize. Temperature for the pre-bake treatment is preferably from 30° C. to 120° C., more preferably from 40° C. to 110° C., and most preferably from 50° C. to 100° C.

The post-bake treatment is carried out to conduct a dehydration/ring-closure (imidization) reaction. Temperature for the post-bake treatment is preferably from 150° C. to 300° C., more preferably from 180° C. to 280° C., and most preferably from 200° C. and 250° C.

The alignment treatment is carried out by rubbing the coating film in a certain direction with a roller wound with a cloth made of nylon, rayon, or cotton fiber according to the requirements.

### Liquid Crystal Display Element:

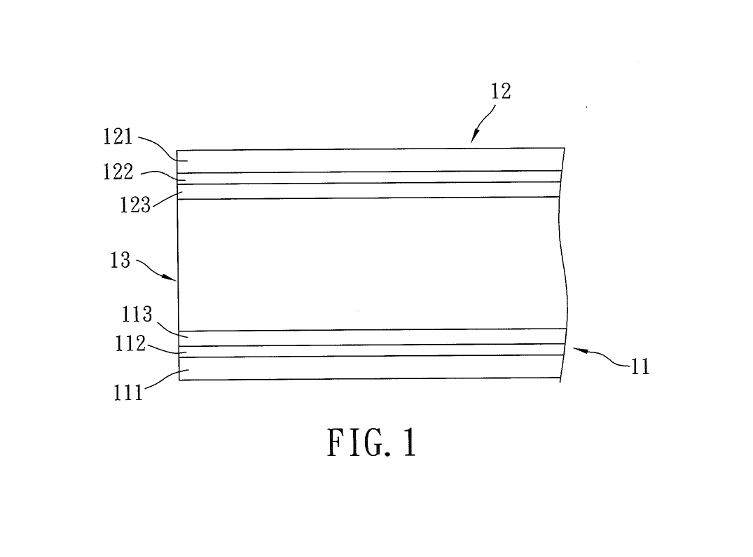

Referring to FIG. 1, a preferred embodiment of a liquid crystal display element according to this invention includes a first unit 11, a second unit 12 spaced apart from the first unit 11, and a liquid crystal unit 13 disposed between the first unit 11 and the second unit 12.

The first unit 11 includes a first substrate 111, a first conductive film 112 formed on the first substrate 111, and a first liquid crystal alignment film 113 formed on the first conductive film 112 and opposite to the first substrate 111.

The second unit 12 includes a second substrate 121, a second conductive film 122 formed on the second substrate 121, and a second liquid crystal alignment film 123 formed on the second conductive film 122 and opposite to the second substrate 121. The first and second liquid crystal alignment films 113, 123 face toward each other.

The first and second substrates 111, 121 suitable for the present invention are made of a transparent material, for example, alkali-free glass, soda-lime glass, hard glass (Pyrex glass), quartz glass, polyethylene terephthalate, polybutylene terephthalate, polyether sulphone, polycarbonate, or the like commonly used in liquid crystal display devices. The first and second conductive films 112, 122 may be a film made of tin oxide (SnO₂), indium oxide-tin oxide (In₂O₃—SnO₂), or the like.

The first and second liquid crystal alignment films 113, 123 are respectively a film made of the liquid crystal alignment agent of the present invention, and are used for providing the liquid crystal unit 13 with a pretilt angle. The liquid crystal unit 13 can be activated by an electric field cooperatively produced by the first and second conductive films 112, 122.

Examples of the liquid crystals suitable for the liquid crystal unit 13 include, but are not limited to, diaminobenzene liquid crystals, pyridazine liquid crystals, Shiff Base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, and cubane liquid crystals. Furthermore, ferroelectric liquid crystals, such as cholesterol liquid crystals, for example, cholesteryl chloride, cholesteryl nonanoate, cholesteryl carbonate, or the like, chiral agents sold under the trade names C-15, CB-15 (manufactured by Merck Company) may be added to the above liquid crystals, as required.

### EXAMPLES

The following examples are provided to illustrate the preferred embodiments of the invention, and should not be construed as limiting the scope of the invention.

### Preparation of Polyamic Acid Compound

### Synthesis Example 1

A 500 ml four-necked conical flask equipped with a nitrogen inlet, a stirrer, a condenser and a thermometer was purged with nitrogen, and was added with a diamine compound having the aforesaid formula (II-9) (5.37 g, 0.01 mole), p-diaminobenzene (4.055 g, 0.0375 mole), 1,2,4-triaminobenzene (0.31 g, 0.0025 mole), and N-methyl-2-pyrrolidone (80 g). Stirring was conducted at room temperature until the diamine compound having the aforesaid formula (II-9), p-diaminobenzene, and 1,2,4-triaminobenzene were dissolved. Pyromellitic dianhydride (10.91 g, 0.05 mole) and N-methyl-2-pyrrolidone (20 g) were then added, and reaction was conducted for 2 hours at room temperature. The reaction solution was then poured into water (1500 ml) to precipitate a polymer. The polymer obtained after filtering was washed with methanol and filtered three times, and was dried in a vacuum oven at 60° C. to obtain a polyamic acid compound (A-1-1).

### Synthesis Examples 2 to 5

Polyamic acid compounds (A-1-2˜A-1-5) were prepared according to the method of Synthesis Example 1 except that the diamine compounds, the multi-amine compound, and the tetracarboxylic dianhydride compounds shown in Table 1 were used instead of the diamine compounds, the multi-amine compound, and the tetracarboxylic dianhydride compound used in Synthesis Example 1.

### Preparation of Polyimide Compound

### Synthesis Example 6

A 500 ml four-necked conical flask equipped with a nitrogen inlet, a stirrer, a condenser and a thermometer was purged with nitrogen, and was added with a diamine compound having the aforesaid formula (II-9) (5.37 g, 0.01 mole), p-diaminobenzene (40.55 g, 0.0375 mole), 1,2,4-triaminobenzene (0.31 g, 0.0025 mole), and N-methyl-2-pyrrolidone (80 g). Stirring was conducted at room temperature until the diamine compound having the aforesaid formula (II-9), p-diaminobenzene, and 1,2,4-triaminobenzene were dissolved. Pyromellitic dianhydride (10.91 g, 0.05 mole) and N-methyl-2-pyrrolidone (20 g) were then added, and reaction was conducted for 6 hours at room temperature. N-methyl-2-pyrrolidone (97 g), acetic anhydride (5.61 g), and pyridine (19.75 g) were then added. Stirring was continued for 2 hours at 60° C. to conduct imidization reaction. The reaction solution was then poured into water (1500 ml) to precipitate a polymer. The polymer obtained after filtering was washed with methanol and filtered three times, and was dried in a vacuum oven at 60° C. to obtain a polyimide compound (A-2-1).

### Synthesis Examples 7 to 15

Polyimide compounds (A-2-2˜A-2-10) were prepared according to the method of Synthesis Example 6 except that the diamine compounds, the multi-amine compounds, and the tetracarboxylic dianhydride compounds shown in Table 1 were used instead of the diamine compounds, the multi-amine compound, and the tetracarboxylic dianhydride compounds used in Synthesis Example 6.

TABLE 1

| | | Synthesis Examples | | | | | | | | | | | | | | |
|---|---|---|---|---|---|---|---|---|---|---|---|---|---|---|---|---|
| Components | | 1 | 2 | 3 | 4 | 5 | 6 | 7 | 8 | 9 | 10 | 11 | 12 | 13 | 14 | 15 |
| (mole %) | | A-1-1 | A-1-2 | A-1-3 | A-1-4 | A-1-5 | A-2-1 | A-2-2 | A-2-3 | A-2-4 | A-2-5 | A-2-6 | A-2-7 | A-2-8 | A-2-9 | A-2-10 |
| Tetracarboxylic | a-1 | 100 | — | — | 100 | — | 100 | — | — | 100 | — | — | 50 | 100 | — | 50 |
| dianhydride | a-2 | — | 100 | 50 | — | 100 | — | 100 | 50 | — | 100 | — | 50 | — | 100 | — |
| components | a-3 | — | — | 50 | — | — | — | — | 50 | — | — | 100 | — | — | — | 50 |
| Diamine | b-1-1 | 20 | — | — | — | 30 | 20 | — | — | 10 | 50 | — | — | 20 | — | — |
| compounds | b-1-2 | — | 27 | — | — | — | — | 27 | — | 10 | — | 5 | 55 | — | — | — |
| represented by | b-1-3 | — | — | 30 | — | — | — | — | 30 | — | — | — | — | — | — | — |
| formula (II) | | | | | | | | | | | | | | | | |
| Other diamine | b-2-1 | 75 | — | — | 95 | — | 75 | — | — | 75 | — | 50 | — | 80 | — | 100 |
| compounds | b-2-2 | — | 70 | — | — | 70 | — | 70 | — | 3 | 49 | 40 | 44 | — | 97 | — |
| | b-2-3 | — | — | 64 | — | — | — | — | 64 | — | — | — | — | — | — | — |
| Multi-amine | c-1 | 5 | — | — | 5 | — | 5 | — | — | — | 1 | 5 | — | — | — | — |
| compounds | c-2 | — | 3 | 4 | — | — | — | 3 | 4 | 2 | — | — | 1 | — | 3 | — |
| represented by | c-3 | — | — | 2 | — | — | — | — | 2 | — | — | — | — | — | — | — |
| formula (I) | | | | | | | | | | | | | | | | |

| | | | | | | | | | | | | | | | |
|---|---|---|---|---|---|---|---|---|---|---|---|---|---|---|---|
| (b-1)/c | 4 | 9 | 5 | 0 | — | 4 | 9 | 5 | 10 | 50 | 1 | 55 | — | 0 | — |
| Imidization ratio (%) | 0 | 0 | 0 | 0 | 0 | 13 | 25 | 34 | 48 | 42 | 63 | 51 | 78 | 65 | 35 |

Notes:
a-1: pyromellitic dianhydride
a-2: 3,4-dicarboxy-1,2,3,4-tetrahydronaphthalene-1-succinic acid dianhydride
a-3: 1,2,4,5-cyclohexane tetracarboxylic dianhydride
b-1-1: a compound represented by formula (II-9)
b-1-2: a compound represented by formula (II-2)
b-1-3: a compound represented by formula (II-10)
b-2-1: p-diaminobenzene
b-2-2: 4,4′-diaminodiphenyl methane
b-2-3: 4,4′-diaminodiphenyl ether
c-1: 1,2,4-triaminobenzene
c-2: 3,3′,4-triaminodiphenyl methane
c-3: 3,3′,4,4′-tetraaminodiphenyl ether

### Preparation of Liquid Crystal Alignment Agent, Liquid Crystal Alignment Film, and Liquid Crystal Display Element

### Example 1

100 parts by weight of the polyamic acid compound of Synthesis Example 1, 725 parts by weight of N-methyl-2-pyrrolidone, and 725 parts by weight of ethylene glycol N-butyl ether were stirred at room temperature to form a liquid crystal alignment agent.

The liquid crystal alignment agent was coated onto two glass substrates each having an ITO (indium-tin-oxide) conductive film using a printing machine (manufactured by Japan Nissha Printing Co., Ltd., Model S15-036), after which the glass substrates coated with the alignment agent solution were pre-baked on a heating plate at a temperature of 100° C. for 5 minutes, and were then post-baked in a hot air circulation baking oven at a temperature of 220° C. for 30 minutes. An alignment process was then carried out on the surface of the film. Two glass substrates each coated with the liquid crystal alignment film were thus manufactured by the aforementioned steps.

Thermo-compression adhesive agent was applied to one glass substrate, and spacers of 4 μm were sprayed on the other glass substrate. The two glass substrates were aligned and bonded together in a vertical direction, and then 10 kg of pressure was applied using a thermocompressor to carry out thermocompression at 150° C. Liquid crystal was poured using a liquid crystal pouring machine (manufactured by Shimadzu Corporation, Model ALIS-100X-CH), ultraviolet light was then used to harden a sealant to seal the liquid crystal injection hole, and an annealing treatment was conducted in an oven at 60° C. for 30 minutes, thereby manufacturing a liquid crystal display element.

The liquid crystal alignment agent and the liquid crystal display element obtained thereby were evaluated according to the following evaluation methods. The evaluation results are shown in Table 2.

### Examples 2-10 and Comparative Examples 1-5

Examples 2-10 and Comparative Examples 1-5 were conducted in a manner identical to Example 1 using the polymer compositions, the solvents, and the additives shown in Table 2 to prepare the liquid crystal alignment agents, the liquid crystal alignment films, and the liquid crystal display elements. The liquid crystal alignment agents, the liquid crystal alignment films, and the liquid crystal display elements thus obtained were evaluated according to the following evaluation methods. The results are shown in Table 2.

### [Evaluation Items]

### 1. Imidization Ratio:

Imidization ratio refers to a ratio of the number of the imide ring to a total of the number of the amic acid functional group and the number of the imide ring in polyimide polymer, and is expressed in percentage.

Each of the polymers obtained in Synthesis Examples 1-15 was dried under a reduced pressure, and was then dissolved in a proper deuteration solvent, for example, deuterated dimethylsulfoxide. ¹H-NMR determination was conducted at room temperature (for example, 25° C.) using tetramethylsilane as a standard. The imidization ratio (in %) was calculated using the following formula:

Imidization ratio(in %)=(1−Δ1/(Δ2×α))×100

wherein

Δ1 is a peak area produced by a chemical shift around 10 ppm of the proton of NH group;

Δ2 is a peak area of the proton other than that of NH group; and

α is a ratio of the number of the proton of NH group to the number of the proton other than that of NH group in a precursor of polyimide polymer (i.e., polyamic acid polymer).

### 2. Viscosity:

Viscosity of each of the liquid crystal alignment agents prepared in Examples 1-10 and Comparative Examples 1-5 was determined using an ELD-type viscometer (manufactured by Toki Sangyo Co., Ltd., RE-80L) at 20 rpm at 25° C. The results are recorded in a unit of cps.

### 3. Process Stability:

Each of the liquid crystal alignment agents prepared in Examples 1-10 and Comparative Examples 1-5 was used to produce a liquid crystal display element. In the process of the liquid crystal display element, the pre-baking treatment was conducted at 80° C., 90° C., 100° C., 110° C., and 120° C. so as to produce five liquid crystal display elements. The pretilt angle uniformity (P) of these liquid crystal display elements was measured, and variation of the pretilt angle uniformity (P) was calculated as follows:

Variation of P=(Pₘₐₓ−Pₘᵢₙ)×100%

Evaluation was conducted according to the following standards:

⊚: Variation of P≦2%

◯: 2%<Variation of P≦5%

Δ: 5%<Variation of P≦10

X: Variation of P>10%

### 4. Reliability:

The test for reliability of the liquid crystal display elements prepared in Examples 1-10 and Comparative Examples 1-5 was carried out at a temperature of 65° C. and relative humidity of 85% for 120 hours. The voltage holding ratio of each of the liquid crystal display elements was measured using an electrical measuring machine (manufactured by TOYO Corporation, Model 6254). A voltage of 4 volts was applied for 2 milliseconds. The applied voltage was held for 1667 milliseconds. After the applied voltage was cut off for 1667 milliseconds, the voltage holding ratio was measured and the reliability of each of the liquid crystal display elements was evaluated according to the following standards:

⊚: Voltage holding ratio ≧94%

◯: 94%>Voltage holding ratio ≧92%

Δ: 92%>Voltage holding ratio ≧90%

X: Voltage holding ratio <90%

TABLE 2

| Components | | Examples | | | | | | | | | | Comparative Examples | | | | |
|---|---|---|---|---|---|---|---|---|---|---|---|---|---|---|---|---|
| (pby) | | 1 | 2 | 3 | 4 | 5 | 6 | 7 | 8 | 9 | 10 | 1 | 2 | 3 | 4 | 5 |
| Polymer | A-1-1 | 100 | — | — | — | — | — | — | — | — | — | — | — | — | — | — |
| compositions | A-1-2 | — | 100 | — | — | — | — | — | — | — | — | — | — | — | — | — |
| | A-1-3 | — | — | 100 | — | — | — | — | — | — | — | — | — | — | — | — |
| | A-1-4 | — | — | — | — | — | — | — | — | — | — | 100 | — | — | — | — |
| | A-1-5 | — | — | — | — | — | — | — | — | — | — | — | 100 | — | — | — |
| | A-2-1 | — | — | — | 100 | — | — | — | — | — | — | — | — | — | — | — |
| | A-2-2 | — | — | — | — | 100 | — | — | — | — | — | — | — | — | — | — |
| | A-2-3 | — | — | — | — | — | 100 | — | — | — | — | — | — | — | — | — |
| | A-2-4 | — | — | — | — | — | — | 100 | — | — | — | — | — | — | — | — |
| | A-2-5 | — | — | — | — | — | — | — | 100 | — | — | — | — | — | — | — |
| | A-2-6 | — | — | — | — | — | — | — | — | 100 | — | — | — | — | — | — |
| | A-2-7 | — | — | — | — | — | — | — | — | — | 100 | — | — | — | — | — |
| | A-2-8 | — | — | — | — | — | — | — | — | — | — | — | — | 100 | — | — |
| | A-2-9 | — | — | — | — | — | — | — | — | — | — | — | — | — | 100 | — |
| | A-2-10 | — | — | — | — | — | — | — | — | — | — | — | — | — | — | 100 |
| Solvents | B-1 | 725 | — | — | 1000 | 1300 | 1500 | — | 1500 | 800 | — | 1000 | — | 725 | 1300 | — |
| | B-2 | 725 | 1500 | — | 500 | — | — | 1200 | — | — | 2000 | 500 | 1500 | 725 | — | 1200 |
| | B-3 | — | — | 1800 | — | 50 | — | — | 200 | 800 | — | — | — | — | 50 | — |
| Additives | C-1 | — | 10 | — | — | — | 8 | — | 5 | — | — | — | 10 | — | — | — |
| | C-2 | — | — | — | 5 | — | 2 | — | — | 3 | — | 5 | — | — | — | — |
| Viscosity (Cps) | | 26 | 21 | 30 | 27 | 21 | 31 | 19 | 33 | 25 | 17 | 26 | 7 | 8 | 20 | 7 |
| Results | Reliability | ⊚ | ⊚ | ⊚ | ⊚ | ⊚ | ⊚ | ⊚ | ⊚ | ◯ | ◯ | X | X | X | X | X |
| | Process | ◯ | ◯ | ◯ | ◯ | ◯ | ⊚ | ⊚ | ⊚ | ⊚ | ⊚ | X | X | X | X | X |
| | Stability | | | | | | | | | | | | | | | |

B-1: N-methyl-2-pyrrolidone
B-2: ethylene glycol n-butyl ether
B-3: N,N-dimethylcetamide
C-1: N,N,N′,N′-tetragylcidyl-4,4′-diaminodiphenylmethane
C-2: N,N-gylcidyl-p-glycidoxyaniline

As shown in Table 2, in Examples 1-10, a combination of the multi-amine component represented by formula (I) and the diamine compound represented by formula (II) is used for obtaining the polymer composition, the liquid crystal alignment agents thus obtained have superior process stability, and the liquid crystal display elements made therefrom have superior reliability.

However, in Comparative Examples 1 and 4, the diamine compound represented by formula (II) was not used for obtaining the polymer composition, the liquid crystal alignment agents thus obtained have inferior process stability, and the liquid crystal display elements made therefrom have inferior reliability.

In Comparative Examples 2 and 3, the multi-amine component represented by formula (I) was not used for obtaining the polymer composition, the liquid crystal alignment agents thus obtained have inferior process stability, and the liquid crystal display elements made therefrom have inferior reliability.

In Comparative Example 5, neither the multi-amine component represented by formula (I) nor the diamine compound represented by formula (II) was used for obtaining the polymer composition, the liquid crystal alignment agents thus obtained have inferior process stability, and the liquid crystal display elements made therefrom have inferior reliability.

Furthermore, in Examples 1-8, a combination of the multi-amine component represented by formula (I) and the diamine compound represented by formula (II) in a molar ratio of the multi-amine component represented by formula (I) to the diamine compound represented by formula (II) ranging from 3 to 50 was used for obtaining the polymer composition, and the liquid crystal alignment agents thus obtained have more superior process stability.

In Examples 6-10, a combination of the multi-amine component represented by formula (I) and the diamine compound represented by formula (II) was used for obtaining the polymer composition in which the imidization ratio ranges from 30% to 80%, and the liquid crystal display elements thus made have more superior reliability.

In view of the aforesaid, in the present invention, a liquid crystal alignment agent having superior process stability can be produced from a polymer composition obtained using a combination of the multi-amine component represented by formula (I) and the diamine compound represented by formula (II). Furthermore, a liquid crystal display element made from the liquid crystal alignment agent has superior reliability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal alignment agent, comprising:
a polymer composition obtained by subjecting a mixture including a tetracarboxylic dianhydride component, a multi-amine component of formula (I), and a diamine component to a reaction,
R¹NH₂)ₐ (I)
wherein
R¹ represents a trivalent organic group or a tetravalent organic group, and
a represents 3 or 4; and
a solvent,
wherein
said diamine component includes a diamine compound of formula (II) and another diamine compound other than said diamine compound of formula (II) 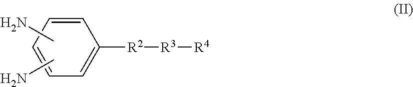
wherein
R² represents a C₁-C₁₂ alkylene group or a C₁-C₁₂ haloalkylene group,
R³ represents 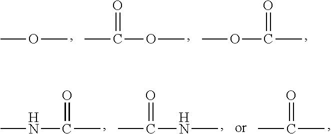
and
R⁴ represents a cholesteryl group, an organic group of formula (III), or a group of —R⁴¹-R⁴²-R⁴³,
wherein
R⁴¹ represents a C₁-C₁₀ alkylene group,
R⁴² represents 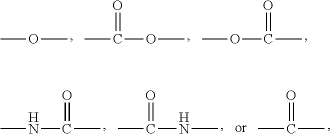
and
R⁴³ represents a cholesteryl group or an organic group of formula (III), 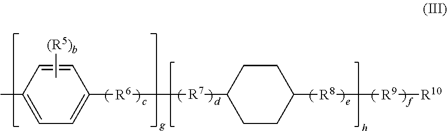
wherein
each R⁵ independently represents hydrogen, fluorine, or methyl,
each of R⁶, R⁷, and R⁸ independently represents a single bond, 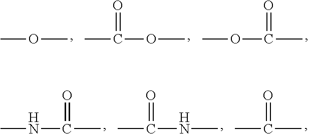
or a C₁-C₃ alkylene,
each R⁹ represents 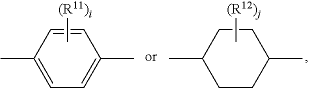
wherein
each of R¹¹ and R¹² independently represents hydrogen, fluorine, or methyl,
each R¹⁰ independently represents hydrogen, fluorine, a C₁-C₁₂ alkyl group, a C₁-C₁₂ fluoroalkyl group, a C₁-C₁₂ alkoxyl group, —OCH₂F, —OCHF₂, or —OCF₃,
b represents 1 or 2,
c, d, and e independently represent an integer ranging from 0 to 4,
f, g, and h independently represent an integer ranging from 0 to 3 with the proviso that f, g, and h are not 0 at the same time, and
i and j independently represent 1 or 2.

2. The liquid crystal alignment agent as claimed in claim 1, wherein said multi-amine component of formula (I) is in an amount ranging from 1 mole to 10 moles and said diamine compound of formula (II) is in an amount ranging from 5 moles to 70 moles based on 100 moles of a combination of said multi-amine component of formula (I) and said diamine component.

3. The liquid crystal alignment agent as claimed in claim 1, wherein a molar ratio of said diamine compound of formula (II) to said multi-amine component of formula (I) ranges from 3 to 50.

4. The liquid crystal alignment agent as claimed in claim 3, wherein said molar ratio of said diamine compound of formula (II) to said multi-amine component of formula (I) ranges from 5 to 40.

5. The liquid crystal alignment agent as claimed in claim 4, wherein said molar ratio of said diamine compound of formula (II) to said multi-amine component of formula (I) ranges from 10 to 30.

6. The liquid crystal alignment agent as claimed in claim 1, wherein said polymer composition has an imidization ratio ranging from 30% to 80%.

7. The liquid crystal alignment agent as claimed in claim 1, having a viscosity at 25° C. ranging from 15 cps to 40 cps.

8. A liquid crystal alignment film formed from the liquid crystal alignment agent as claimed in claim 1.

9. A liquid crystal display element, comprising the liquid crystal alignment film as claimed in claim 8.
